(19) United States
(12) Patent Application Publication
(10) Pub. No.: US 2026/0133343 A1
(43) Pub. Date: May 14, 2026

(54) RAIN GAUGE WITH AN OIL-EXCLUDING SIPHON

(71) Applicant: Oregon State University, Corvallis, OR (US)

(72) Inventor: John Selker, Corvallis, OR (US)

(73) Assignee: Oregon State University, Corvallis, OR (US)

(21) Appl. No.: 18/948,349

(22) Filed: Nov. 14, 2024

(51) Int. Cl. G01W 1/14

(52) U.S. Cl. CPC G01W 1/14

(57) ABSTRACT

A rain gauge comprising a vessel having an interior surrounded by a first wall. The rain gauge further includes an oil-excluding siphon comprising a tube partially within the interior of the vessel, and extending through an opening through the first wall of the vessel, wherein an inlet to the flexible tube is within the interior of the vessel and an outlet of the tube is outside the vessel. The rain gauge further includes an oil-excluding portion that is attached to the tube near the inlet, wherein the oil-excluding portion is permanently bent or is elastically bendable. In at least one example, the rain gauge includes at least one hole is in a second wall of the oil-excluding portion.

### BACKGROUND

Rain gauges may be employed in many areas, including agriculture, forestry, airports, climate observation stations, and other applications. Accumulating rain gauges consist of a vessel for gathering rain and measuring rainfall as the height of the accumulated rainfall level in the vessel. To stem evaporation, a layer of a nonvolatile oil may be added to the rain gauge, capping the water layer. A problem may arise when draining the rain gauge to manage to keep the oil in the device, and to avoid contamination from any oil that escapes into the environment. In field situations where the rain gauges are read periodically, the water may need to be drained from the rain gauges frequently. This requires a field visit by a technician, and often involves lifting accumulators weighing over 30 kg from within a very delicate instrument. Simply pouring off the water may cause entrainment of some of the oil layer with the decanted water, thus eventually causing loss of the oil layer.

### BRIEF DESCRIPTION OF DRAWINGS

Material described herein is illustrated by way of example and not by way of limitation in accompanying figures. For simplicity and clarity of illustration, elements illustrated in figures are not necessarily drawn to scale and exact locations. For example, dimensions of some elements can be exaggerated relative to other elements for clarity. Also, various physical features can be represented in their simplified “ideal” forms and geometries for clarity of discussion, but it is nevertheless to be understood that practical embodiments can only approximate illustrated ideals. For example, smooth surfaces and square intersections can be drawn in disregard of finite roughness, corner-rounding, and imperfect angular intersections characteristic of structures formed by nanofabrication techniques. Further, where considered appropriate, reference labels have been repeated among figures to indicate corresponding or analogous elements.

FIG. 1 is a schematic illustrating a cross-sectional view of a rain gauge having an oil-excluding siphon, in accordance with at least one embodiment.

FIG. 2A is a schematic illustrating a first part of a method sequence for using the rain gauge and oil-excluding siphon shown in FIG. 1, in accordance with at least one embodiment.

FIG. 2B is a schematic illustrating a second part of a method sequence for using the rain gauge and oil-excluding siphon shown in FIG. 1, in accordance with at least one embodiment.

FIG. 2C shows a cross-sectional view of rain gauge, in accordance with at least one embodiment.

FIG. 3 is a schematic illustrating a cross-sectional view of an alternative embodiment of a rain gauge having an oil-excluding siphon, in accordance with at least one embodiment.

FIG. 4A is a schematic illustrating a first part of a method sequence for using the rain gauge and oil-excluding siphon shown in FIG. 3, in accordance with at least one embodiment.

FIG. 4B is a schematic illustrating a second part of the method sequence for using the rain gauge and oil-excluding siphon shown in FIG. 3, in accordance with at least one embodiment.

FIG. 4C is a schematic illustrating a third part of the method sequence for using the rain gauge and oil-excluding siphon shown in FIG. 3, in accordance with at least one embodiment.

FIG. 5 is a flowchart summarizing an exemplary method for using a rain gauge having an oil-excluding siphon, in accordance with at least one embodiment.

### DETAILED DESCRIPTION

Immiscible liquids such as oil and water may be difficult to separate completely in some industrial settings. These settings may include edible and non-edible oil packaging and distribution facilities, milk and dairy processing facilities, and some chemical processing facilities where water-soluble solids are extracted from non-aqueous liquids by water or water-based solutions. Crude preparations of food liquids or edible oils may contain a high percentage of water that must be separated. A crude edible oil, such as soy oil, may be extracted from soybeans using water, which mixes with the oil. The mixture may be processed in a vat or in a large drum, such as a 55-gallon drum. It may be desired to remove the water by letting the mixture separate into an aqueous layer and an oil layer, which floats on top of the water layer. The oil may simply be siphoned or poured out the vessel, but it may be difficult to remove the water completely as some of the water may unavoidably be removed with the desired oil product since, for example, a siphon may be submerged even a small depth within the aqueous layer. The same problems may be found in the petroleum industry, where water infiltration into stored oil or gasoline may be extensive enough to produce a layer at the bottom of the storage vessel. In some chemical manufacturing, an oil-based product may be produced in an aqueous solvent having water-soluble reactants. The oil-based product may build up during the course of the reaction and form a substantial portion of the reaction volume. An economy may be realized in the separation steps after the reaction is complete if the crude oil-based product may be removed from the reaction vessel without any of the aqueous solvent.

High-grade rain gauges may have an automated means of measuring the accumulated rainfall (including weighing the total mass of the rainfall in the collection vessel), but many do not have such a means of reading the rainfall data and must be read manually. If the rain gauge cannot be read immediately, some evaporation may take place that would reduce accuracy of rainfall measurements. Further, accumulating rain gauges may have automated telemetry for accumulated mass, but not automated self-empty, requiring technicians to visit the site periodically simply to empty the water from the device. In some instances, to drain the rain gauge, siphoning may be used to remove the water and attempt to retain the oil layer. However, the siphon may inevitably suck out some of the oil layer once the water layer is almost completely removed.

Described herein is a rain gauge comprising an oil-excluding siphon. In at least one embodiment, the oil excluding siphon comprises a tube bent into a “Z” or “N” shape at one end, whereby the tube has two sharp opposing bends a distance from one end. A hole is present at a first bend of the “N” segment, whereby the first bend is closest to the end of the tube. In at least one embodiment, the length of an end segment of the tube, which can be an orthogonal leg of the N-shape, where the end segment is between the end of the tube and the first bend, is approximately equal to the depth of the oil layer. The tube continues vertically to a rim of the vessel or to an opening in the vessel wall, where the tube continues out of and vertically downward, extending below the bottom of the vessel as a siphon. The siphon may work in a normal fashion to drain an aqueous layer below a layer of oil, which floats on top. In at least one embodiment, the N-shaped portion of the siphon is completely submerged in liquid. As the aqueous layer is drained, the level of liquid drops in the vessel. Eventually, the level of the oil layer contacts the N-shaped portion of the siphon and exposes the hole in the first bend of the N-shaped portion. As the hole emerges from the surface of the oil layer, air enters the tube and breaks the siphon.

Here, “siphon” is used as a noun or verb, where the noun is the device, or a state of suction of the device where it spontaneously sucks or pumps a liquid from one place to another by gravity flow. The draining action is initiated by manually or machine pumping water through the main tube of the siphon device. At this point, liquid stops draining from the end of the siphon outside the vessel. The oil layer is preserved without being co-decanted with the aqueous layer. The remaining oil may be kept in the vessel or removed by pouring the oil into a different vessel. To remove all the aqueous layer, the submerged end of the tube may be pressed against the bottom of the vessel. In this way, a desired aqueous product or desired oil product may be separated from a waste oil or water-based layer.

In at least one embodiment, a rain gauge having an oil-excluding siphon is described. The rain gauge may be a vessel that is designed to capture and measure rain. The rain gauge comprises a vessel, such as a cylinder or other shaped container, and an oil-excluding siphon attached to the vessel. In at least one embodiment, the oil-excluding siphon has a first end of the tube inserted into the vessel and extends through a hole in the vessel wall to the exterior, where a second end of the tube may be maintained below the floor of the vessel. In at least one embodiment, a squeezable bulb is included in line with the siphon tube on the exterior of the vessel. In at least one embodiment, the bulb is to initiate a flow within the siphon by creating a suction within the tube to pull water from the vessel to the exterior.

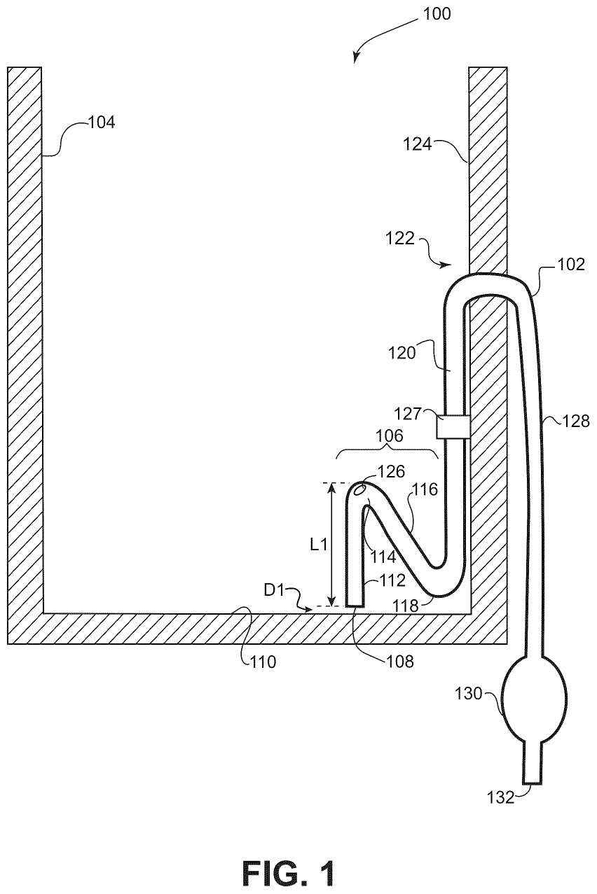

FIG. 1 illustrates a cross-sectional view of a rain gauge 100 comprising a siphon 102, in accordance with at least one embodiment. In at least one embodiment, siphon 102 is partially within the interior of vessel 104. In at least one example, siphon 102 is configured as an oil-excluding siphon. In at least one embodiment, siphon 102 comprises a flexible or rigid tube having an oil-excluding portion 106 near an inlet 108 of the tube that is within the interior of vessel 104. In at least one embodiment, oil-excluding portion 106 generally has multiple bends. In at least one embodiment, oil-excluding portion 106 may generally have a zig-zap shape, for example, an “N” shape or a “Z” shape, and is oriented such that inlet 108 is placed a first distance D1 above bottom surface 110 of vessel 104. In at least one embodiment, oil-excluding portion 106 may have a more gradual “S” shape, where bends are more curved and gentler than sharper bends found in a zig-zag shape. In at least one embodiment, oil-excluding portion 106 comprises a short vertical segment 112, followed by a first bend 114. A diagonal segment 116 extends between first bend 114 and second bend 118, followed by a long vertical segment 120 that extends upward to aperture 122 through wall 124 of vessel 104. Long vertical segment 120 (ascending along the interior wall) and long vertical segment 128 (descending along the exterior wall) may be the main portion of the flexible or rigid tube of the siphon. In at least one embodiment, a hole 126 is located on a first bend 114 of oil-excluding portion 106. In at least one embodiment, oil-excluding portion 106 comprises a rigid thermosetting or thermoplastic material that permanently retains the zig-zag shape. In at least one example, the rigid thermosetting or thermoplastic material may be selected to be hydroscopic to limit oil entry into the hole until it is exposed to air. Long vertical segments 120 and/or 128 may comprise a thin-walled flexible silicone rubber or other elastomer such as a butyl rubber. Other non-elastomeric thermoplastic polymers such as polyethylene sheet may be used for long vertical segments 120 and/or 128.

In at least one embodiment, long vertical segment 120 of siphon 102 is secured to wall 124 by bracket 127. Siphon 102 also comprises long vertical segment 128 on the exterior of vessel 104, extending downward from aperture 122. In at least one embodiment, a bulb 130 may be attached to outlet 132 of siphon 102. In at least one embodiment, bulb 130 may be replaced by a mechanical pump.

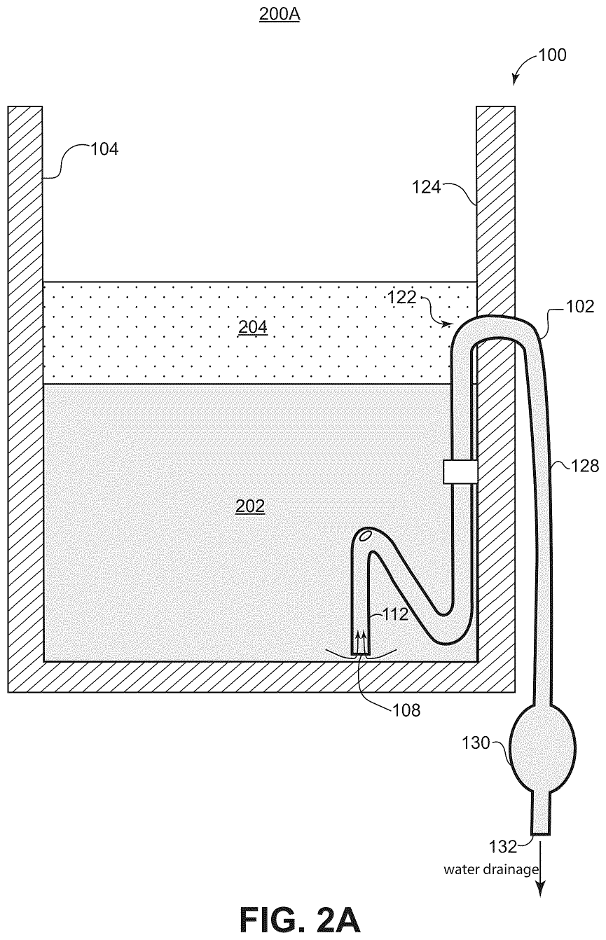

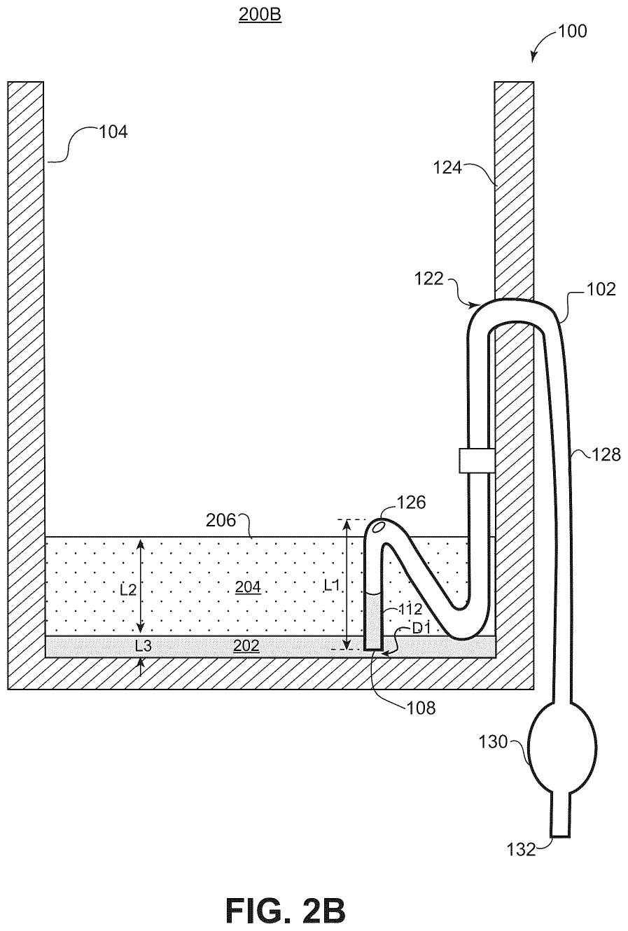

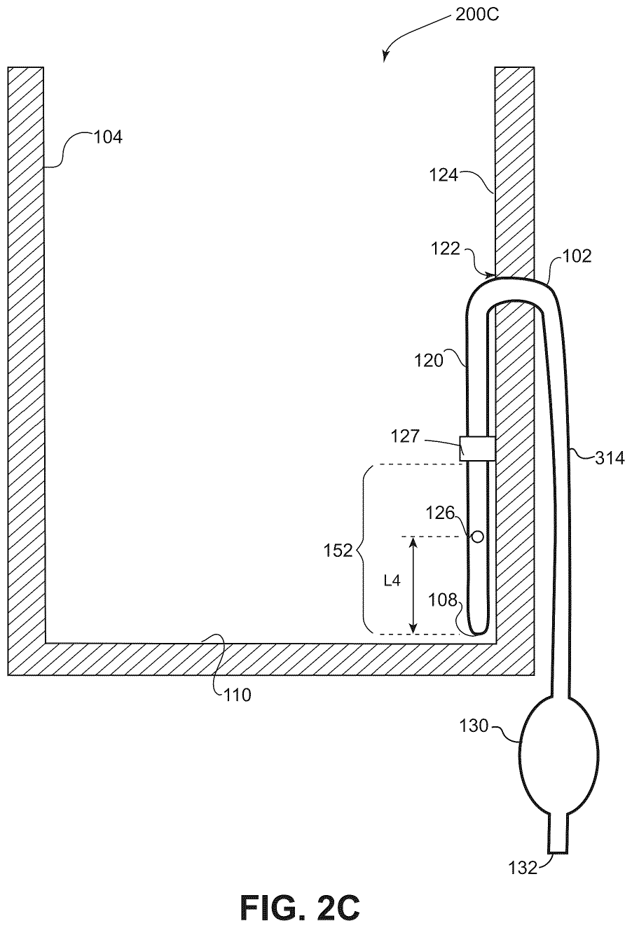

FIGS. 2A, 2B, and 2C are schematics 200A, 200B, and 200C, respectively, illustrating use of rain gauge 100, in accordance with some embodiments. FIG. 2A shows schematic 200A of the method sequence. In schematic 200A, rain gauge 100 is filled with a water layer 202 and an oil layer 204 floating on top of water layer 202. Water layer 202 may be the result of rainfall collection, and oil layer 204 placed in vessel 104 prior to rainfall collection. Water accumulating within vessel 104 falls from above and drops through oil layer 204 to collect at the bottom of vessel 104. In the illustration, rain gauge 100 is being drained by siphon 102 after a rainfall measurement. For example, bulb 130 is pumped to pull water into the tube of siphon 102 and up through aperture 122, then down to outlet 132 at the end of long vertical segment 128 by gravity flow. The small pressure head that is created by the difference in height between outlet 132 and inlet 108, where the heights are measured relative to some common reference such as ground, drives the flow.

FIG. 2B shows schematic 200B of the method sequence. In schematic 200B, rain gauge is substantially emptied of water. Oil layer 204 drops to a level where hole 126 is exposed to the atmosphere. At this point, the siphon is broken and the siphoning action ceases. Water layer 202 does not drain completely. A residual layer of water remains in which inlet 108 remains immersed. In this configuration, siphoning action of siphon 102 is stopped via exposure of hole 126 to air as top surface 206 of oil layer 204 drops below hole 126. Thus, the siphon is broken before any oil from oil layer 204 can enter siphon 102.

In at least one embodiment, height L2 of oil layer 204 may be equal to or smaller than L1, the length of short vertical segment 112. A minimal level L3 of residual water in water layer 202 may depend on L2. For example, as L2 approaches L1, L3 approaches a minimum. The lower limit of L3 may be D1, the distance between inlet 108 and bottom surface 110 of vessel 104. Thus, the thickness L2 of oil layer 204 may be adjusted to a desired value by choice of the length L1 of short vertical segment 112.

FIG. 2C shows a cross-sectional view of rain gauge schematic 200C, in accordance with at least one example. In the illustrative embodiment, rain gauge 150 is substantially the same as rain gauge 100 shown in FIG. 1. Here, oil excluding portion 106 comprises a straight tube instead of a bent tube, having one hole 126 a height L4 above inlet 108. The height L4 may be approximately the thickness of an oil layer added to rain gauge 150 during use. L4 may be 3 to 5 mm, for example. Here, oil excluding portion 106 may be rigid or flexible extension of siphon 102. While a single hole 126 is shown in this perspective, in some examples, a second hole can be placed on the opposite side of the oil excluding portion 106 (for example, opposite from hole 126 and facing hole 126). The second hole may be at the same height or vertically displaced from hole 126.

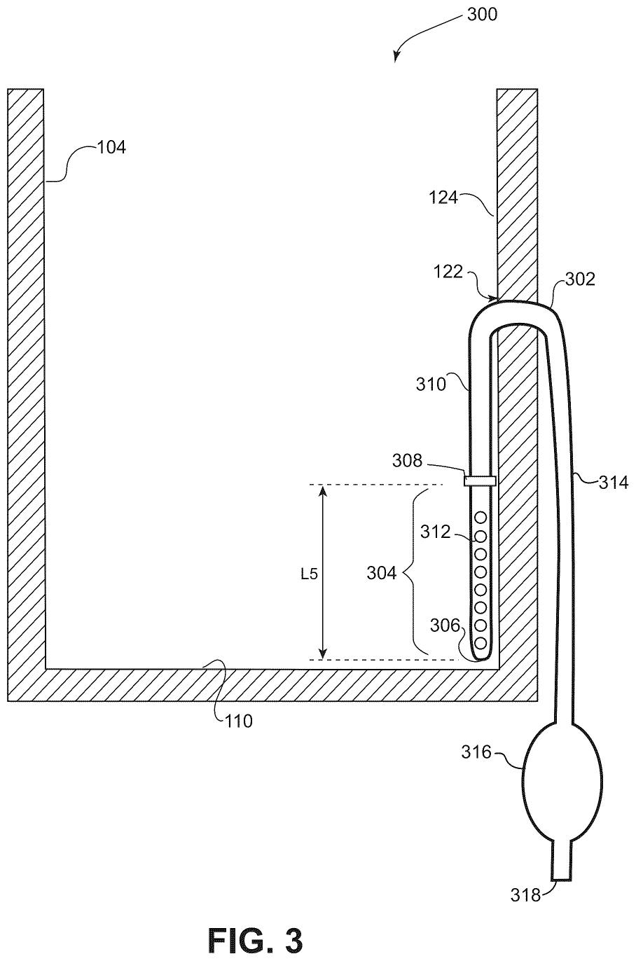

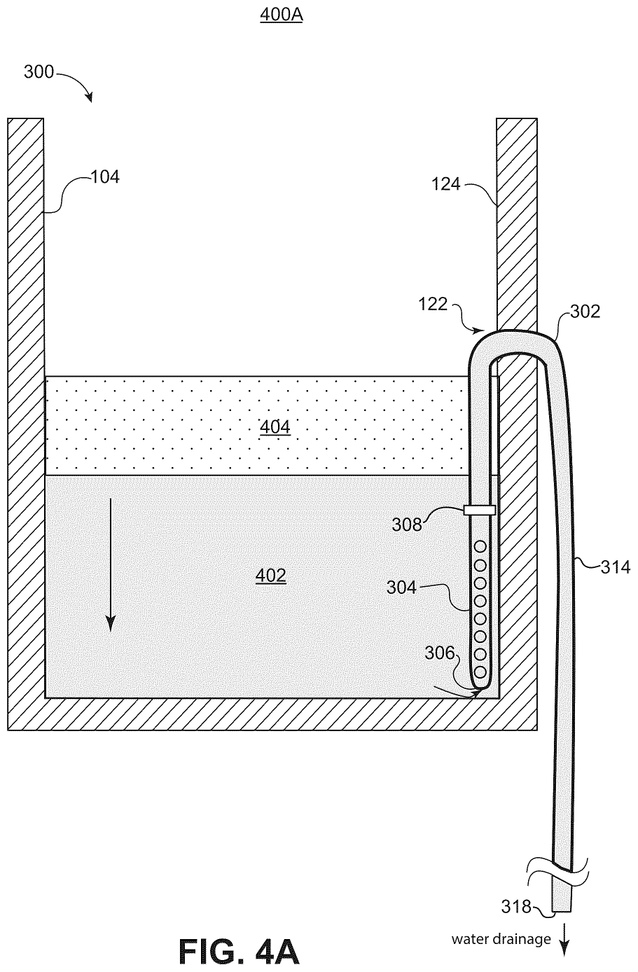

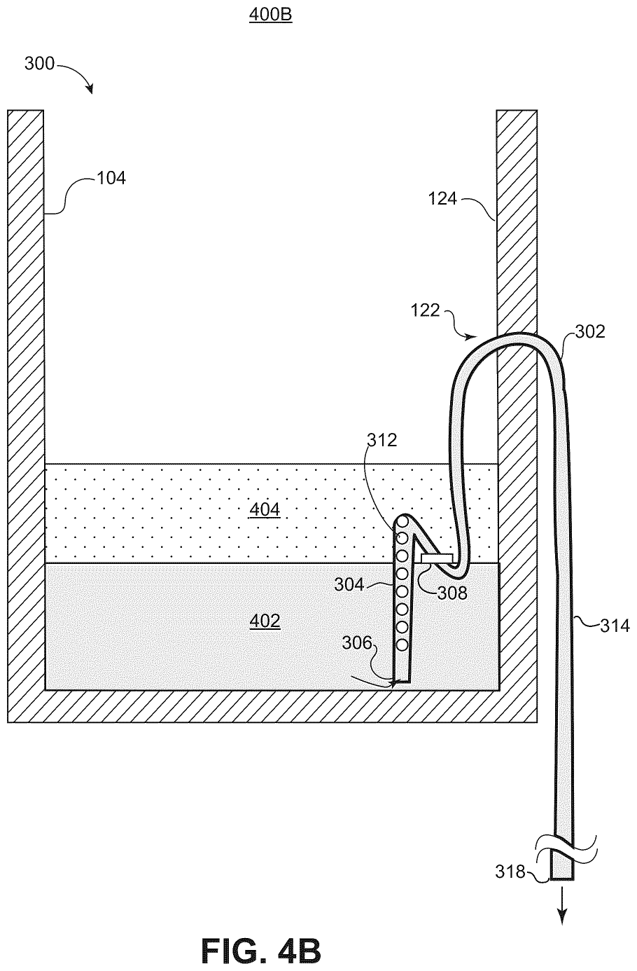

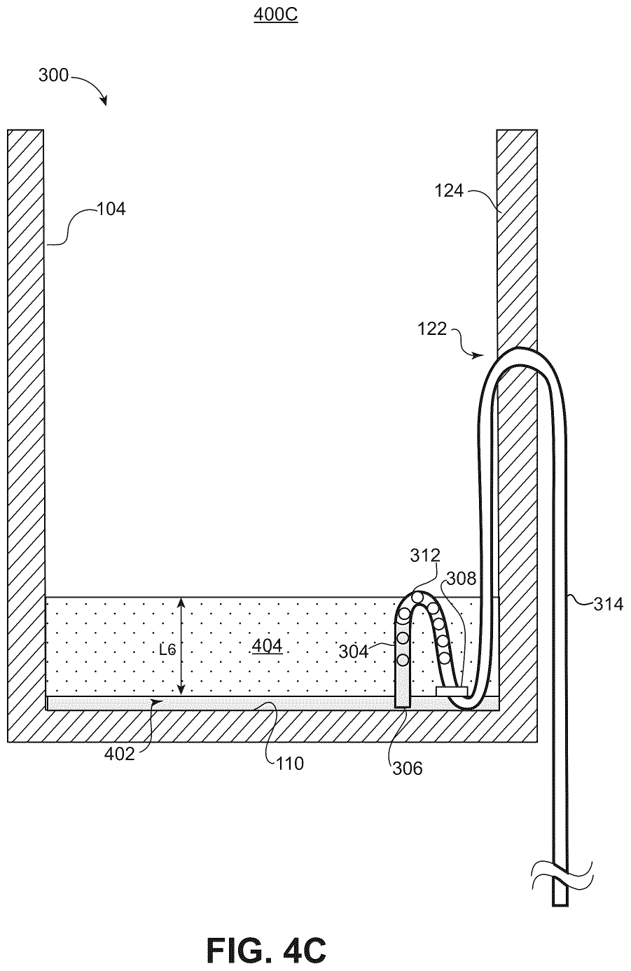

FIG. 3 illustrates a cross-sectional view of an alternative embodiment of rain gauge 300. In at least one embodiment, rain gauge 300 comprises vessel 104, which is substantially identical to vessel 104 of rain gauge 100 shown in FIG. 1. Rain gauge 300 further includes siphon 302, which comprises oil-excluding portion 304 immediately above inlet 306 of siphon 302. Oil-excluding portion 304 may comprise a soft and bendable elastomer, such as a silicone rubber, and extends a height L5 above inlet 306 to a floatation/sinker ring 308 along vertical portion 310. In at least one embodiment, oil-excluding portion 304 comprises a thin-walled flexible rubber, such as a silicone that is readily subject to elastic distortion. Oil-excluding portion 304 may be initially strait, and not bent or folded. Floatation/sinker ring 308 comprises a material that has a density less than that of water but greater than that of an oil chosen for an oil layer (see FIGS. 4A-C), floatation/sinker ring 308 may be attached to siphon 302 by an adhesive that permanently attaches to the material of siphon wall. For example, siphon 302 may comprise a silicone rubber. floatation/sinker ring 308 may be attached to vertical portion 310 at a suitable height L5 from inlet 306 along vertical portion 310. Oil-excluding portion 304 comprises a series of holes 312. Holes 312 are sized to limit infiltration of oil into siphon 302. The series of holes 312 permits the stoppage of siphoning action for unknown or arbitrary thicknesses of an oil layer floating above a water layer within vessel 104.

In at least one embodiment, vertical portion 310 extends up wall 124 of vessel 104, and exits through aperture 122 to the exterior. A second vertical segment 314 of siphon 302 extends downward to bulb 316, situated above outlet 318. In at least one embodiment, aperture 122 is sealed around siphon 302 to allow filling of vessel 104 above the level of aperture 122. Vertical portion 310 within the interior of vessel 104 may be any suitable length to accommodate oil-excluding portion 304.

FIGS. 4A-C are schematics 400A, 400B, and 400C, respectively, for using rain gauge 300, in accordance with some embodiments. FIG. 4A illustrates schematic 400A of the method sequence. A rain gauge 300 is shown to be in the process of being drained of its water layer 402. Floating above water layer 402 is oil layer 404. At this stage, oil-excluding portion 304 is still fully submerged in water layer 402. Ring 308 has a density that permits it to float in water layer 402. As ring 308 floats within water layer 402, oil-excluding portion 304 is held upright while ring 308 remains submerged in water layer 402. Almost all the water that flows in siphon 302 enters through inlet 306. By comparison, holes 312 let in virtually no water as their size may be chosen to be smaller than inlet 306. For example, flow through an opening is inversely proportional to the fourth power of the diameter. If the diameter of holes 312 is 10% that of inlet 306, then flow through inlet 306 is 10,000 greater than flow through any of holes 312. As will be shown below, the higher viscosity of oils compared to water (e.g., soy oil viscosity approximately 50 centipoise (cP) at 25° C. versus water viscosity of approximately 1 cP at 25° C.) aids in preventing oil from entering through holes 312. Thus, as the rate of flow of a fluid through an opening is inversely proportional to the viscosity of the fluid, flow of oil into holes 312 would theoretically be approximately 1/500,000^{th} of the flow of water into inlet 306. It is noted that while bulb 316 is not shown in FIGS. 4A-C, it is understood to be part of siphon 302.

FIG. 4B illustrates schematic 400B of the method sequence, in accordance with at least one embodiment. In schematic 400B, water layer 402 is drained further from vessel 104, but continues to drain. The lowering of the water level brings oil layer 404 in contact with oil-excluding portion 304 of siphon 302, now placing an upper part of oil-excluding portion 304 within oil layer 404. Within oil layer 404, ring 308 now acts as a sinker, dropping to the bottom of oil layer 404, but floating at the interface between oil layer 404 and water layer 402. This pulls an upper part of oil-excluding portion 304 downward, causing bending in oil-excluding portion 304. Wall thickness and material stiffness of oil-excluding portion 304 may be engineered to allow oil-excluding portion 304 to readily bend without collapsing the lumen (e.g., hollow interior) of siphon 302.

FIG. 4C illustrates schematic 400C of the method sequence, in accordance with at least one example. In schematic 400C, water layer 402 is almost completely drained, leaving a small layer at the bottom of vessel 104. Oil layer 404 has a thickness of L6, which may be less than L5, the length of oil-excluding portion 304. An appropriate selection of L5 and L6 permits exposure of one or more holes 312 to the atmosphere, breaking siphon. Siphon may be broken while water layer 402 is thick enough to leave inlet 306 still submerged in water layer 402, preventing oil from entering siphon 302 through inlet 306. Multiple holes 312 allow a good amount of imprecision in hole placement, allowing for exclusion of oil layers having arbitrary thicknesses.

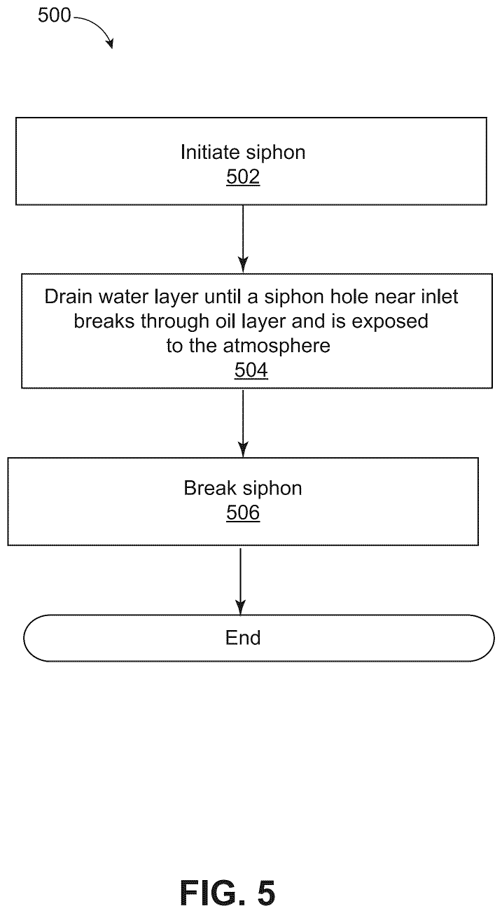

FIG. 5 illustrates a flowchart 500 summarizing an exemplary method for using a rain gauge, such as rain gauge 100 or rain gauge 300 having an oil-excluding siphon, in accordance with some embodiments.

At operation 502 a rain gauge such as rain gauge 100 or rain gauge 300 is filled with rainwater from a storm or rainy period. An oil-excluding siphon such as siphon 102 or 302 is part of the rain gauge. A portion or tail of the siphon (e.g., vertical segment 314) extends through an opening (e.g., aperture 122) within the wall of the rain gauge vessel (e.g., vessel 104). In at least one embodiment, the siphon incorporates a squeezable bulb (e.g., bulb 316). To initiate siphon, the bulb is squeezed multiple times to pump water into the inlet and let it exit the outlet (e.g., outlet 318). As noted above, the term “siphon” is used as a noun or verb, where the noun is the device, or a state of suction of the device where it spontaneously sucks or pumps a liquid from one place to another by gravity flow. The draining action is initiated by manually or machine pumping water through the main tube of the siphon device. Pressure head due to the height difference between the inlet and outlet of the siphon drives gravity flow of the water. In at least one embodiment, a mechanical pump may be used to initiate siphon in lieu of a squeezable bulb. Siphon may also be initiated by mouth suction through the outlet of the flexible or rigid tube.

At operations 504 and 506, water drains out of the siphon until the oil layer (e.g., oil layer 204 or 404) drops low enough within the rain gauge vessel to contact the folded portion (e.g., oil-excluding portion 106) or a collapsible straight portion (e.g., oil-excluding portion 304) of the siphon. Once a hole (e.g., hole 126 or one or more of holes 312) is exposed to the atmosphere, siphon will break as air enters the interior of the siphon. Here, the entirety of the oil layer is retained within the rain gauge vessel to be reused without refilling the rain gauge, allowing more convenient use of the rain gauge.

Here, some methods and devices may be shown in block diagram form, rather than in detail, to avoid obscuring present disclosure. Reference throughout this specification to “an embodiment,” “one embodiment,” or “some embodiments” means that a particular feature, structure, function, or characteristic described in connection with an embodiment is included in at least one embodiment of disclosure. Thus, appearances of phrase “in an embodiment,” “in one embodiment,” “in at least one embodiment,” or “some embodiments” in various places throughout this specification are not necessarily referring to same embodiment of disclosure. Furthermore, particular features, structures, functions, or characteristics can be combined in any suitable manner in one or more embodiments. For example, a first embodiment can be combined with a second embodiment anywhere particular features, structures, functions, or characteristics associated with two embodiments are not mutually exclusive. A list of definitions follows, whereby following definitions may provide or augment literal support for claims.

As used in herein, singular forms “a,” “an,” and “the” are intended to include plural forms as well, unless context clearly indicates otherwise. It will also be understood that term “and/or” as used herein refers to and encompasses all possible combinations of one or more of associated listed items.

Here, “coupled” and “connected,” along with their derivatives, may be used herein to describe functional or structural relationships between components. These terms are not intended as synonyms for each other. Rather, in particular embodiments, “connected” may be used to indicate that two or more elements are in direct physical, optical, or electrical contact with each other. “Coupled” may be used to indicated that two or more elements are in either direct or indirect (with other intervening elements between them) physical, electrical or in magnetic contact with each other, and/or that two or more elements co-operate or interact with each other (e.g., as in a cause an effect relationship). Coupled may also have the meaning of non-mechanical contact or connection. Coupling may also have the meaning of thermal connectivity, where one object may be a heat source and another object may be a heat sink, either in thermal equilibrium with each other or subject to a common conductive, convective or radiative heat flow between them; electrically coupled, where objects may be connected electrically in an electric or electronic circuit and a current flow may be induced by application of a voltage between the electrically interconnected objects or by an electric field between mechanically coupled or isolated objects; magnetically, where two mechanically coupled or isolated objects mutually share a common magnetic field flux; and fluidically, where objects such as vessels and conduits may share a common gas or liquid fluid that is static or flowing.

Here, a device that is “configured to” perform a task or function may be configured (e.g., programmed and/or hardwired) at a time of manufacturing by a manufacturer to perform the function. In at least one example, the device may be configurable (or reconfigurable) by a user after manufacturing to perform the function and/or other additional or alternative functions. In at least one example, the configuring may be through firmware and/or software programming of the device, through a construction and/or layout of hardware components and interconnections of the device, or a combination thereof.

Here, “between” may be employed in context of z-axis, x-axis, or y-axis of a device. A material that is between two other materials may be in contact with one or both of those materials. In another example, a material that is between two or other material may be separated from both of other two materials by one or more intervening materials. A material “between” two other materials may therefore be in contact with either of other two materials. In another example, a material “between” two other materials may be coupled to other two materials through an intervening material. A device that is between two other devices may be directly connected to one or both of those devices. In another example, a device that is between two other devices may be separated from both of other two devices by one or more intervening devices.

Here, “over,” “under,” “between,” and “on” can generally refer to a relative position of one component or material with respect to other components or materials where such physical relationships are noteworthy. Unless these terms are modified with “direct” or “directly,” one or more intervening components or materials can be present. Similar distinctions are to be made in context of component assemblies. As used throughout this description, and in claims, a list of items joined by term “at least one of” or “one or more of” can mean any combination of listed terms.

Here, “left,” “right,” “front,” “back,” “top,” “bottom,” “over,” “under,” and similar terms are used for descriptive purposes and not necessarily for describing permanent relative positions. For example, terms “over,” “under,” “front side,” “back side,” “top,” “bottom,” “over,” “under,” and “on” as used herein refer to a relative position of one component, structure, or material with respect to other referenced components, structures, or materials within a device, where such physical relationships are noteworthy. These terms are employed herein for descriptive purposes only and predominantly within context of a device z-axis and therefore may be relative to an orientation of a device. Hence, a first material “over” a second material in context of a figure provided herein may also be “under” second material if device is oriented upside-down relative to context of figure provided. Similar distinctions are to be made in context of component assemblies.

Here, “adjacent” can generally refer to a position of a thing being next to (e.g., immediately next to or close to with one or more things between them) or adjoining another thing (e.g., abutting it).

Unless otherwise specified in explicit context of their use, terms “substantially equal,” “about equal,” and “approximately equal” can generally mean that there is no more than incidental variation between two things so described. In at least one embodiment, such variation is no more than +/−10% of referred value.

In the following paragraphs, examples are provided that illustrate various embodiments. Here, examples can be combined with other examples. As such, various embodiments can be combined with other embodiments without changing scope of disclosure.

Example 1 is a rain gauge comprising: a vessel having an interior surrounded by a first wall; an oil-excluding siphon comprising a flexible tube partially within the interior of the vessel, and extending through an opening through the first wall of the vessel, wherein an inlet to the flexible tube is within the interior of the vessel and an outlet of the flexible tube is outside the vessel; an oil-excluding portion that is attached to the flexible tube near the inlet, wherein the oil-excluding portion is permanently bent or is elastically bendable; and at least one hole in a second wall of the oil-excluding portion.

Example 2 is a rain gauge according to any example herein, in particular example 1, wherein the oil-excluding portion has an “N” shape and comprises a rigid thermoset plastic.

Example 3 is a rain gauge according to any example herein, in particular example 1, wherein the at least one hole occurs on a bend of the oil-excluding portion.

Example 4 is a rain gauge according to any example herein, in particular example 1, wherein the oil-excluding portion comprises an elastomer and has a first wall thickness that is less than a second wall thickness of a main portion of the flexible tube.

Example 5 is a rain gauge according to any example herein, in particular example 1, wherein the oil-excluding portion has multiple holes distributed along a length of the oil-excluding portion.

Example 6 is a rain gauge according to any example herein, in particular example 1, wherein a floatation/sinker ring is attached to the flexible tube near a junction of the oil-excluding portion and a main portion of the flexible tube.

Example 7 is a rain gauge according to any example herein, in particular example 1, wherein the tube is a flexible tube.

Example 8 is a rain gauge according to any example herein, in particular example 1, wherein the tube is a rigid tube.

Example 9 is a method for using a rain gauge, comprising: partially filling the rain gauge with an oil to a predetermined thickness, wherein the rain gauge comprises: a vessel having an interior surrounded by a first wall; a siphon comprising a flexible tube partially within the interior of the vessel, and extending through an opening through the first wall of the vessel, wherein an inlet to the flexible tube is within the interior of the vessel and an outlet of the flexible tube is outside the vessel; a portion that is attached to the flexible tube near the inlet, wherein the portion is permanently bent or is elastically bendable; and at least one hole in a second wall of the portion; allowing the vessel to partially fill with rainwater; initiating a suction within the siphon; draining water from the vessel until an oil layer contacts the portion; and breaking the siphon when the at least one hole in the portion is exposed to atmosphere.

Example 10 is a method according to any example herein, in particular example 9, wherein initiating the siphon within the siphon comprises: pumping a squeezable bulb attached to the flexible tube near the outlet to pump the water into the flexible tube; and allowing flow of the water within the flexible tube until it exits through the outlet.

Example 11 is a method according to any example herein, in particular example 9, wherein breaking siphon when the at least one hole in the portion is exposed to the atmosphere comprises exposing a hole on a bend of a zig-zag shaped oil-excluding portion to the atmosphere, wherein an upper surface of the oil layer drops below a height of the hole.

Example 12 is a method according to any example herein, in particular example 9, wherein breaking siphon when the at least one hole in the portion is exposed to the atmosphere comprises having an elastic bendable oil-excluding portion and a floatation/sinker ring attached to the flexible tube just above the portion, wherein the floatation/sinker ring comprises a material having a density less than that of the water and more than that of the oil, wherein the floatation/sinker ring is configured to bend the portion until the oil layer drops to a level, and wherein the at least one hole is exposed to the atmosphere.

Example 13 is a rain gauge comprising: a vessel having an interior surrounded by a first wall; a siphon comprising a flexible tube partially within the interior of the vessel, and extending through an opening through the first wall of the vessel, wherein an inlet to the flexible tube is within the interior of the vessel and an outlet of the flexible tube is outside the vessel; a portion that is attached to the flexible tube near the inlet, wherein the portion is permanently bent or is elastically bendable; and at least one hole in a second wall of the portion.

Example 14 is a rain gauge according to any example herein, in particular example 13, wherein the portion has an “N” shape and comprises a rigid thermoset plastic.

Example 15 is a rain gauge according to any example herein, in particular example 13, wherein the at least one hole occurs on a bend of the portion.

Example 16 is a rain gauge according to any example herein, in particular example 13, wherein the portion comprises an elastomer and has a first wall thickness that is less than a second wall thickness of a main portion of the flexible tube.

Example 17 is a rain gauge according to any example herein, in particular example 13, wherein the portion has multiple holes distributed along a length of the portion.

Example 18 is a rain gauge according to any example herein, in particular example 13, wherein a floatation/sinker ring is attached to the flexible tube near a junction of the portion and a part of the flexible tube.

Example 19 is a rain gauge according to any example herein, in particular example 13, wherein the portion is configured as an oil-excluding portion.

Example 20 is a rain gauge according to any example herein, in particular example 1, wherein the tube is a flexible tube or a rigid tube.

Besides what is described herein, various modifications can be made to disclosed embodiments and embodiments thereof without departing from their scope. Therefore, illustrations of embodiments herein should be construed as examples, and not restrictive to scope of present disclosure.

What is claimed is:

1. A rain gauge comprising:
a vessel having an interior surrounded by a first wall;
an oil-excluding siphon comprising a tube partially within the interior of the vessel, and extending through an opening through the first wall of the vessel, wherein an inlet to the tube is within the interior of the vessel and an outlet of the tube is outside the vessel;
an oil-excluding portion that is attached to the tube near the inlet, wherein the oil-excluding portion is permanently bent or is elastically bendable; and
at least one hole in a second wall of the oil-excluding portion.

2. The rain gauge of claim 1, wherein the oil-excluding portion has an “N” shape and comprises a rigid thermoset plastic.

3. The rain gauge of claim 1, wherein the at least one hole occurs on a bend of the oil-excluding portion.

4. The rain gauge of claim 1, wherein the oil-excluding portion comprises an elastomer and has a first wall thickness that is less than a second wall thickness of a main portion of the tube.

5. The rain gauge of claim 1, wherein the oil-excluding portion has multiple holes distributed along a length of the oil-excluding portion.

6. The rain gauge of claim 1, wherein a floatation/sinker ring is attached to the tube near a junction of the oil-excluding portion and a main portion of the tube.

7. The rain gauge of claim 1, wherein the tube is a flexible tube.

8. The rain gauge of claim 1, wherein the tube is a rigid tube.

9. A method for using a rain gauge, comprising:
partially filling the rain gauge with an oil to a predetermined thickness, wherein the rain gauge comprises:
a vessel having an interior surrounded by a first wall;
a siphon comprising a tube partially within the interior of the vessel, and extending through an opening through the first wall of the vessel, wherein an inlet to the tube is within the interior of the vessel and an outlet of the tube is outside the vessel;
a portion that is attached to the tube near the inlet, wherein the portion is permanently bent or is elastically bendable; and
at least one hole in a second wall of the portion;
allowing the vessel to partially fill with rainwater;
initiating a suction within the siphon;
draining water from the vessel until an oil layer contacts the portion; and
breaking the siphon when the at least one hole in the portion is exposed to atmosphere.

10. The method of claim 9, wherein initiating the siphon within the siphon comprises:
pumping a squeezable bulb attached to the tube near the outlet to pump the water into the tube; and
allowing flow of the water within the tube until it exits through the outlet.

11. The method of claim 9, wherein breaking siphon when the at least one hole in the portion is exposed to the atmosphere comprises exposing a hole on a bend of a zig-zag shaped oil-excluding portion to the atmosphere, wherein an upper surface of the oil layer drops below a height of the hole.

12. The method of claim 9, wherein breaking the siphon when the at least one hole in the portion is exposed to the atmosphere comprises having an elastic bendable oil-excluding portion and a floatation/sinker ring attached to the tube just above the portion, wherein the floatation/sinker ring comprises a material having a density less than that of the water and more than that of the oil, wherein the floatation/sinker ring is configured to bend the portion until the oil layer drops to a level, and wherein the at least one hole is exposed to the atmosphere.

13. A rain gauge comprising:
a vessel having an interior surrounded by a first wall;
a siphon comprising a tube partially within the interior of the vessel, and extending through an opening through the first wall of the vessel, wherein an inlet to the tube is within the interior of the vessel and an outlet of the tube is outside the vessel;
a portion that is attached to the tube near the inlet, wherein the portion is permanently bent or is elastically bendable; and
at least one hole in a second wall of the portion.

14. The rain gauge of claim 13, wherein the portion has an “N” shape and comprises a rigid thermoset plastic.

15. The rain gauge of claim 13, wherein the at least one hole occurs on a bend of the portion.

16. The rain gauge of claim 13, wherein the portion comprises an elastomer and has a first wall thickness that is less than a second wall thickness of a main portion of the tube.

17. The rain gauge of claim 13, wherein the portion has multiple holes distributed along a length of the portion.

18. The rain gauge of claim 13, wherein a floatation/sinker ring is attached to the tube near a junction of the portion and a part of the tube.

19. The rain gauge of claim 13, wherein the portion is configured as an oil-excluding portion.

20. The rain gauge of claim 13, wherein the tube is a flexible or rigid tube.
